(19) United States
(12) Patent Application Publication
(10) Pub. No.: US 2024/0073861 A1
(43) Pub. Date: Feb. 29, 2024

(54) CAPABILITY SENDING METHOD AND APPARATUS, AND CAPABILITY DETERMINATION METHOD AND APPARATUS

(71) Applicant: Beijing Xiaomi Mobile Software Co., Ltd., Beijing (CN)

(72) Inventor: Wei HONG, Beijing (CN)

(21) Appl. No.: 18/256,502

(22) PCT Filed: Dec. 8, 2020
(86) PCT No.: PCT/CN2020/134692

§ 371 Date: Jun. 8, 2023

(51) Int. Cl. H04W 68/02

(52) U.S. Cl. CPC H04W 68/02; H04W 88/06

(57) ABSTRACT

A method for sending capability is performed by a base station, and includes: sending system information, wherein the system information carries capability information; wherein the capability information is configured to indicate a problem, that the base station is capable of solving, of communication conflict of a plurality of subscriber identity module (SIM) cards in a terminal.

### CROSS-REFERENCE

The present application is a U.S. National Stage of International Application No. PCT/CN2020/134692, filed on Dec. 8, 2020, the entire content of which is incorporated herein by reference.

### TECHNICAL FIELD

The present disclosure relates to a field of communication technology, and more particularly to a method for sending capability, a method for determining capability, an apparatus for sending capability, an apparatus for determining capability, an electronic device, and a computer-readable storage medium.

### BACKGROUND

In a multi-card terminal, a plurality of SIM (Subscriber Identity Module) cards may be set, and the terminal may communicate through the plurality of SIM cards. However, during communication process, a communication conflict problem may occur of the plurality of SIM cards, which may affect communication effect of the terminal. Hereto, the communication conflict may be solved by a base station.

### SUMMARY

In view of this, the embodiment of the present disclosure proposes a method for sending capability, a method for determining capability, an apparatus for sending capability, an apparatus for determining capability, an electronic device, and a computer-readable storage medium to solve technical problems in the related art.

According to a first aspect of the present disclosure, a method for sending capability is performed by a base station and includes:
sending system information, wherein the system information carries capability information;
wherein the capability information is used to indicate a problem, that the base station is capable of solving, of communication conflict of a plurality of SIM cards in a terminal.

According to a second aspect of the present disclosure, a method for determining capability is performed by a terminal and includes:
receiving system information sent by a base station, wherein the system information carries capability information;
determining, according to the capability information, a problem, that the base station is capable of solving, of communication conflict of a plurality of SIM cards in the terminal.

According to a third aspect of the present disclosure, a base station includes:
a processor; and
a memory for storing executable instructions of the processor;
wherein the processor is configured to execute the above method for sending capability.

According to a fourth aspect of the present disclosure, a terminal includes:
a processor; and
a memory for storing executable instructions of the processor;
wherein the processor is configured to execute the above method for determining capability.

### BRIEF DESCRIPTION OF THE DRAWINGS

The accompanying drawings are incorporated in and constitute a part of this specification. It should be noted that the accompanying drawings are introduced to describe some embodiments of the present disclosure, and those skilled in the art can obtain other embodiments.

FIG. 1 is a schematic flow diagram of a method for sending capability according to an embodiment of the present disclosure.

FIG. 2 is a schematic flow chart of a method for determining capability according to an embodiment of the present disclosure.

FIG. 3 is a schematic flow diagram of another method for determining capability according to an embodiment of the present disclosure.

FIG. 4 is a schematic flow chart of yet another method for determining capability according to an embodiment of the present disclosure.

FIG. 5 is a schematic flow chart of yet another method for determining capability according to an embodiment of the present disclosure.

FIG. 6 is a schematic flow chart of yet another method for determining capability according to an embodiment of the present disclosure.

FIG. 7 is a schematic block diagram of an apparatus for sending capability according to an embodiment of the present disclosure.

FIG. 8 is a schematic block diagram of an apparatus for determining capability according to an embodiment of the present disclosure.

FIG. 9 is a schematic block diagram of another apparatus for determining capability according to an embodiment of the present disclosure.

FIG. 10 is a schematic block diagram of yet another apparatus for determining capability according to an embodiment of the present disclosure.

FIG. 11 is a schematic block diagram of yet another apparatus for determining capability according to an embodiment of the present disclosure.

FIG. 12 is a schematic block diagram of yet another apparatus for determining capability according to an embodiment of the present disclosure.

FIG. 13 is a schematic block diagram of an apparatus for sending capability according to an embodiment of the present disclosure.

FIG. 14 is a schematic block diagram of an apparatus for determining capability according to an embodiment of the present disclosure.

### DETAILED DESCRIPTION

The technical solutions in the embodiments of the present disclosure will be clearly and fully described below in conjunction with the accompanying drawings in the embodiments of the present disclosure. Apparently, the described embodiments are only example embodiments of the present disclosure, rather than all of the embodiments. Based on the embodiments of the present disclosure, other embodiments obtained by those of ordinary skill in the art may fall within the protection scope of the present disclosure.

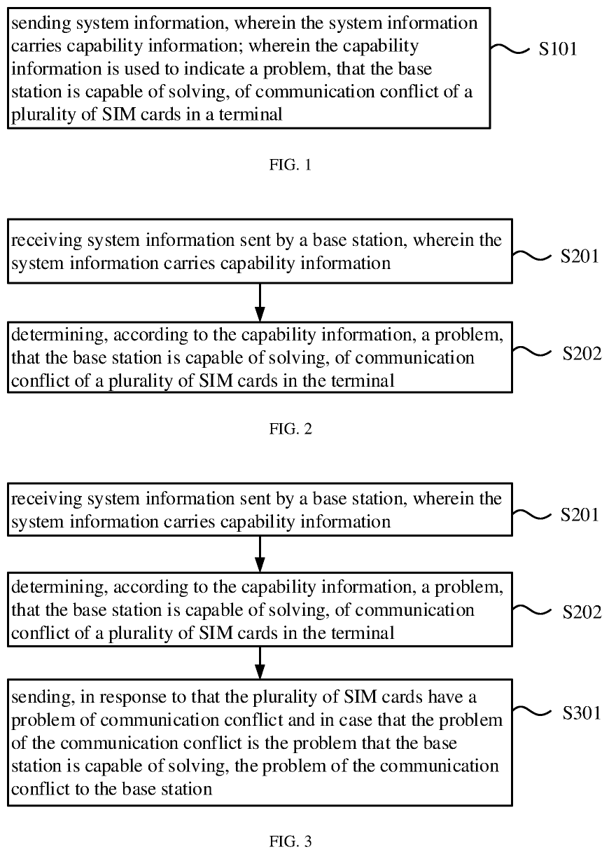

FIG. 1 is a schematic flow diagram of a method for sending capability according to an embodiment of the present disclosure. The method for sending capability illustrated in the present embodiment may be applicable to a base station, and the base station includes, but is not limited, to a 4G base station, a 5G base station, and a 6G base station. The base station may communicate with a terminal served as a user equipment, and the terminal includes, but is not limited to, an electronic device such as a mobile phone, a tablet computer and a wearable device, a sensor, and an Internet of Things device. In an embodiment, the terminal may be a terminal to which the method for determining capability in any following embodiment is applicable.

As illustrated in FIG. 1, the method for sending capability may include the following step S101:
in step S101, the system information is sent, and the system information carries capability information;
the capability information is used to indicate a problem, that the base station is capable of solving, of communication conflict of a plurality of SIM cards in a terminal.

In an embodiment, the base station may send system information in a manner of broadcasting, and the base station may continuously broadcast the system information, or broadcast the system information in on demand manner.

In an embodiment, the terminal that receives the system information may be a multi-card terminal or a single-card terminal. In general, there is a problem of communication conflict of the plurality of SIM cards in the multi-card terminal. Thus, the following embodiment mainly is described by an example of the multi-card terminal receiving the system information.

A plurality of SIM cards may be set in the multi-card terminal. The SIM cards may be traditional SIM cards, eSIM cards, or embedded SIM cards. The plurality of SIM cards may belong to the same operator network or different operator networks. The following exemplary illustrations are provided in case of the plurality of SIM cards including a first SIM card and a second SIM card.

The communication conflict between the first SIM card and the second SIM card include but are not limited to two cases:
a first case is that a communication operation required by the first SIM card conflicts with a communication operation required by the second SIM card, a paging occasion of the first SIM card in response to paging and a paging occasion of the second SIM card in response to paging overlap in a time domain, so there is paging collision between the first SIM card and the second SIM card;
a second case is that the terminal needs to use the second SIM card for communication in the process of communication using the first SIM card, and there is a communication conflict between a communication operation being carried out by the first SIM card and a communication operation needed to be carried out by the second SIM card, which leads to the interruption of the communication process of the first SIM card, especially in a case that the terminal does not have a hang-up mechanism, the problem caused by the communication conflict is more serious.

In the second case, there are many types of communication conflicts between the first SIM card and the second SIM card:

For example, when the first SIM card communicates with a first base station, the second SIM card needs to respond to a paging message (such as initiating random access) after receiving the paging message sent by a second base station. In this case of communication conflict, if the terminal cannot determine whether to continue the communication of the first SIM card or respond to the paging message through the second SIM card, it may cause a problem in the communication process of the terminal. If the terminal achieves to respond to the paging message through the second SIM card according to itself, the terminal automatically disconnects a RRC (Radio Resource Control) connection between the first SIM card and the first base station, and responds to a paging message sent by the second SIM card, which may cause that the first base station mistakenly considers a fault in the communication of the first SIM card and thus pages the first SIM card in order to re-establish the connection with the first SIM card, resulting in a waste of paging resources.

For example, when the first SIM card communicates with the first base station, the second SIM card needs to monitor a paging message sent by the second base station, which requires the terminal to leave an accessed first base station. For example, when the first SIM card communicates with the first base station, the second SIM card needs to measure a signal sent by the second base station, which requires the terminal to leave an accessed first base station. Both of receiving paging sent from the second base station or measuring a signal (e.g., measuring signal strength) sent from the second base station require the terminal to leave an accessed first base station, which usually takes about 20 ms. For the first base station, this period of time of leaving the first base station is mistaken as shadow fading and may also occur periodically. In order to avoid the shadow fading, the first base station adjusts a sending power and a link adaptation algorithm, resulting in a waste of resources of the first base station.

For example, when the first SIM card communicates with the first base station, the second SIM card needs to receive the system information sent by the second base station, which requires the terminal to leave the accessed first base station, usually for about 1 second. For example, when the first SIM card communicates with the first base station, the second SIM card needs to communicate with the second base station to perform Tracking Area Update (TAU), which requires the terminal to leave the accessed first station, usually for several seconds. Both of them may cause the first base station to mistakenly consider that there is an error in communication with the first SIM card, so as to take the corresponding operation, which also cause a waste of resources of the first base station.

With respect to the above problem of communication conflict, the base station may have the ability to solve it. However, the capability varies from base station to base station and problems of the communication conflict that can be solved may vary.

According to the embodiment of the present disclosure, the base station may carry the capacity information in the system information that is sent, and indicate the problem, that the base station is capable of solving, of the communication conflict of the plurality of SIM cards in the terminal through the capacity information, such that the terminal that receives the system information may determine, according to the capacity information in the system information, which kind of problem, that the base station is capable of solving, of the communication conflict.

In an embodiment, when the terminal has a problem of communication conflict of the plurality of SIM cards, the terminal may determine, according to the capability information in the system information, which kind of the problem, that the base station is capable of solving, of the communication conflict, and sends the problem of the communication conflict to the base station only when the base station is capable of solving the problem of the communication conflict of the terminal. However, when the base station is not capable of solving the problem of the communication conflict of the terminal, the terminal may not send the problem of the communication conflict to the base station, to avoid wasting communication resources.

In an embodiment, when the terminal has a problem of communication conflict of the plurality of SIM cards, the terminal may first judge whether it is capable of solving the problem of the communication conflict, and if not, then send the problem of the communication conflict to the base station.

In an embodiment, the system information may be newly set system information, which is different from existing system information. The system information may also be obtained by modifying the existing system information.

In an embodiment, the system information may be minimum system information (SI), and the base station may continuously broadcast the system information.

In an embodiment, the base station may first determine a terminal within its coverage, and determine a multi-card terminal therein, and then carry an identification of the multi-card terminal in the capability information. After receiving the system information, a non-multi-card terminal doesn't need to continue to parse the capability information if an identification obtained when parsing the capability information is different from its own identification, which is conducive to reducing the consumption of the non-multi-card terminal. However, after receiving the system information, the multi-card terminal may continue to parse the capability information if an identification obtained when parsing the capability information is the same as its own identification, so as to determine what kind of the problem, that the base station is capable of solving, of the communication conflict.

In an embodiment, the system information may be other system information (other SI).

In an embodiment, the other system information is on demand system information, which is not continuously broadcast system information, but is broadcast after receiving a request from the terminal.

In an embodiment, the problem that the base station is capable of solving includes at least one of the following:
paging collision of the plurality of SIM cards in the terminal;
a first SIM card in the terminal being in a process of communication, and a second SIM card in the terminal being required to respond to a paging message;
the terminal leaving a currently accessed base station due to the communication conflict of the plurality of SIM cards.

In an embodiment, the problem that the base station is capable of solving includes the paging collision of the plurality of SIM cards in the terminal, and the capability information is further used to indicate a manner for the base station to solve the paging collision of the plurality of SIM cards in the terminal.

In an embodiment, the manner includes at least one of the following:
changing a user equipment identification of the SIM card, providing an offset corresponding to a user equipment identification of the SIM card, changing an algorithm for determining a paging occasion based on a user equipment identification of the SIM card.

In an embodiment, the problem that the base station is capable of solving may include the paging collision of the plurality of SIM cards in the terminal, and there may be one or a plurality of manners to solve the paging collision. The capability information may specifically indicate the manner for the base station to solve the paging collision of the plurality of SIM cards, such that the terminal may determine the manner by which the base station is capable of solving the paging collision.

In an embodiment, when the plurality of SIM cards in the terminal have the paging collision, on the basis of determining that the base station is capable of solving the paging collision, the manner for the base station to solve the paging collision may be further determined. If the manner is a manner required by the terminal, the problem of the communication conflict may be sent to the base station, otherwise it is unnecessary to send the problem of the communication conflict to the base station.

For example, the base station is capable of solving the paging collision in a manner of changing the algorithm for determining the paging occasion based on the user equipment identification of the SIM card, but the terminal does not support changing the algorithm for determining the paging occasion based on the user equipment identification of the SIM card, so when the terminal has the paging collision problem, the terminal may not send the problem of the communication conflict to the base station, so as to avoid the waste of the communication resources in the case that the base station cannot solve the problem of the communication conflict.

For example, the base station is capable of solving the paging collision in a manner of changing the user equipment identification of the SIM card, and the terminal supports changing the user equipment identification of the SIM card, so when the terminal has the paging collision problem, the terminal may send the problem of the communication conflict to the base station.

In an embodiment, the problem that the base station is capable of solving includes that the terminal leaves the currently accessed base station due to the communication conflict of the plurality of SIM cards, and the capability information is further used to indicate a type of the communication conflict that the base station is capable of solving.

In an embodiment, the type of the communication conflict includes at least one of the following:
when the terminal communicates with a first base station through the first SIM card, a paging message sent by a second base station being monitored through the second SIM card;
when the terminal communicates with a first base station through the first SIM card, a signal sent by a second base station being measured through the second SIM card;
when the terminal communicates with a first base station through the first SIM card, system information sent by a second base station being received through the second SIM card;
when the terminal communicates with a first base station through the first SIM card, tracking area update being performed through the second SIM card communicating with a second base station.

In an embodiment, the problem that the base station is capable of solving may include that the terminal leaves the currently accessed base station due to the communication conflict of the plurality of SIM cards. Since there may be a plurality of types of the communication conflicts of the plurality of SIM cards, the capability information may specifically indicate which type of the communication conflict, causing the terminal leaves the currently accessed base station, that the base station is capable of solving.

In an embodiment, when the terminal leaves the currently accessed base station due to the communication conflict of the plurality of SIM cards, on the basis of determining that the base station is capable of solving the problem of the communication conflict, where the problem of the communication conflict is trigger by the communication conflict of the plurality of SIM card which causes the terminal leaving the currently accessed base station, the type of the communication conflict that the base station is capable of solving may be further determined, and that is, the type of the communication conflict that triggers the terminal to leave the currently accessed base station may be combined. If this type is a type of the communication conflict that occurs in the terminal, the problem of the communication conflict may be sent to the base station, otherwise, it is unnecessary to send the problem of the communication conflict to the base station, so as to avoid wasting communication resources when the base station cannot solve the problem of the communication conflict.

For example, the base station is capable of solving the problem of the communication conflict triggered by the following: when communicating with the first base station through the first SIM card, the terminal monitoring the paging message sent by the second base station through the second SIM card. The terminal may not send the problem of the communication conflict to the base station if it is triggered to leave the currently accessed first base station due to communication with the second base station for tracking area update through the second SIM card while communicating with the first base station through the first SIM card, and the terminal may send the problem of the communication conflict to the base station if it is triggered to leave the currently accessed first base station due to monitoring the paging message sent by the second base station through the second SIM card while communicating with the first base station through the first SIM card.

FIG. 2 is a schematic flow chart of a method for determining capability according to an embodiment of the present disclosure. The method for determining capability illustrated in the present embodiment may be applicable to a terminal, and the terminal includes, but is not limited to, an electronic device such as a mobile phone, a tablet computer and a wearable device, a sensor, and an Internet of Things device. The terminal may communicate with a base station served as a user equipment. The base station includes, but is not limited to, a 4G base station, a 5G base station, and a 6G base station. In an embodiment, the base station may be a base station to which the method for sending capability described in any of the above embodiments is applicable.

As illustrated in FIG. 2, the method for determining capability may include the following steps S201 and S202:
in step S201, the system information sent by the base station is received, wherein the system information carries capability information;
in step S202, according to the capability information, it is determined that a problem, that the base station is capable of solving, of communication conflict of a plurality of SIM cards in the terminal.

In an embodiment, the base station may send the system information in a manner of broadcasting, and the terminal that receives the system information may be a multi-card terminal or a single-card terminal. A plurality of SIM cards may be set in the multi-card terminal. The SIM cards may be traditional SIM cards, eSIM cards, or embedded SIM cards. The plurality of SIM cards may belong to the same operator network or different operator networks. The following exemplary illustrations are provided in case of the plurality of SIM cards including a first SIM card and a second SIM card.

According to the embodiment of the present disclosure, the base station may carry the capacity information in the system information that is sent, and indicate the problem, that the base station is capable of solving, of the communication conflict of the plurality of SIM cards in the terminal through the capacity information, such that the terminal that receives the system information may determine, according to the capacity information in the system information, which kind of problem, that the base station is capable of solving, of the communication conflict.

FIG. 3 is a schematic flow diagram of another method for determining capability according to an embodiment of the present disclosure. As illustrated in FIG. 3, in some embodiments of the present disclosure, the method for determining capability further includes S301:
in step S301, in response to that the plurality of SIM cards have a problem of communication conflict and in case that the problem of the communication conflict is the problem that the base station is capable of solving, the problem of the communication conflict is sent to the base station.

In an embodiment, when the terminal has a problem of communication conflict of the plurality of SIM cards, the terminal may determine, according to the capability information in the system information, which kind of the problem, that the base station is capable of solving, of the communication conflict, and sends the problem of the communication conflict to the base station only when the base station is capable of solving the problem of the communication conflict of the terminal. However, when the base station is not capable of solving the problem of the communication conflict of the terminal, the terminal may not send the problem of the communication conflict to the base station, to avoid wasting communication resources.

FIG. 4 is a schematic flow chart of yet another method for determining capability according to an embodiment of the present disclosure. As illustrated in FIG. 4, in some embodiments of the present disclosure, the method for determining capability further includes S401:
in step S401, auxiliary information is sent to the base station, wherein the auxiliary information is used to assist the base station to solve the problem of the communication conflict of the terminal.

In an embodiment, the auxiliary information includes at least one of the following:
a manner of solving the problem of the communication conflict of the terminal, a time of solving the problem of the communication conflict of the terminal, a priority of solving the problem of the communication conflict of the terminal.

In an embodiment, the terminal may not only send the problem of the communication conflict to the base station, but also send auxiliary information to the base station, so as to assist the base station to solve the problem of the communication conflict of the terminal.

For example, the auxiliary information is a manner of solving the problem of the communication conflict of the terminal, and the base station may use this manner to solve the problem of the communication conflict of the terminal;

For example, the auxiliary information is the time of solving the problem of the communication conflict of the terminal, and the base station is capable of solving the problem of the communication conflict of the terminal at the above time;

For example, the auxiliary information is the priority of solving the problem of the communication conflict of the terminal, the terminal may determine the priorities of the plurality of communication operations where the communication conflicts occur, and solve the problem of the communication conflict according to a principle that a communication operation with a highest priority may be performed first, so as to ensure that the communication operation with the highest priority may be performed first and ensure the user's experience.

In an embodiment, the problem that the base station is capable of solving includes at least one of the following:
paging collision of the plurality of SIM cards in the terminal;
a first SIM card in the terminal being in a process of communication, and a second SIM card in the terminal being required to respond to a paging message;
the terminal leaving a currently accessed base station due to the communication conflict of the plurality of SIM cards.

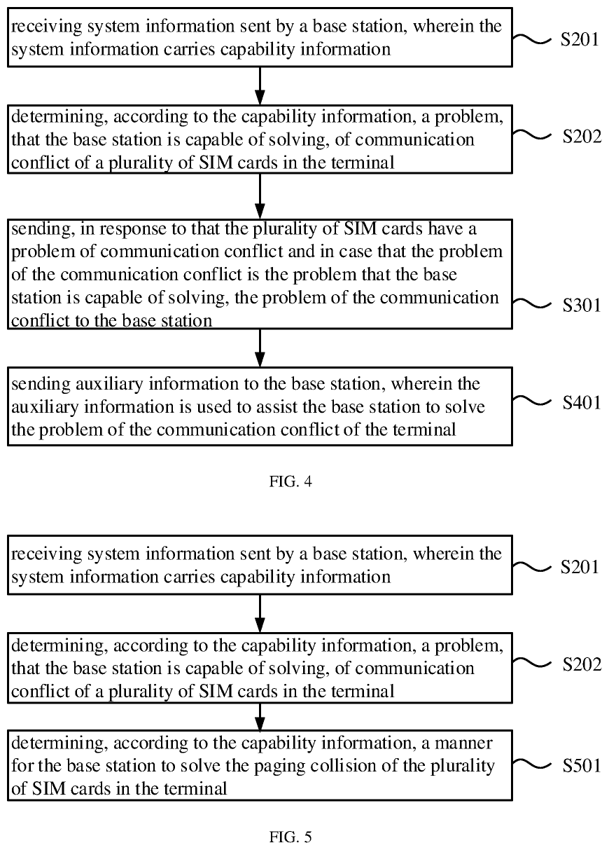

FIG. 5 is a schematic flow chart of yet another method for determining capability according to an embodiment of the present disclosure. As illustrated in FIG. 5, in some embodiments of the present disclosure, the problem that the base station is capable of solving include the paging collision of the plurality of SIM cards in the terminal, and the method further includes S501:
in step S501, a manner for the base station to solve the paging collision of the plurality of SIM cards in the terminal is determined according to the capability information.

In an embodiment, the manner includes at least one of the following:
changing a user equipment identification of the SIM card, providing an offset corresponding to a user equipment identification of the SIM card, changing an algorithm for determining a paging occasion based on a user equipment identification of the SIM card.

In an embodiment, when the plurality of SIM cards in the terminal have the paging collision, on the basis of determining that the base station is capable of solving the paging collision, the manner for the base station to solve the paging collision may be further determined. If the manner is a manner required by the terminal, the problem of the communication conflict may be sent to the base station, otherwise it is unnecessary to send the problem of the communication conflict to the base station.

For example, the base station is capable of solving the paging collision in a manner of changing the algorithm for determining the paging occasion based on the user equipment identification of the SIM card, but the terminal does not support changing the algorithm for determining the paging occasion based on the user equipment identification of the SIM card, so when the terminal has the paging collision problem, the terminal may not send the problem of the communication conflict to the base station, so as to avoid the waste of the communication resources in the case that the base station cannot solve the problem of the communication conflict.

For example, the base station is capable of solving the paging collision in a manner of changing the user equipment identification of the SIM card, and the terminal supports changing the user equipment identification of the SIM card, so when the terminal has the paging collision problem, the terminal may send the problem of the communication conflict to the base station.

FIG. 6 is a schematic flow chart of yet another method for determining capability according to an embodiment of the present disclosure. As illustrated in FIG. 6, in some embodiments of the present disclosure, the problem that the base station is capable of solving include that the terminal leaves the currently accessed base station due to the communication conflict of the plurality of SIM cards, and the method further includes S601:
in step S601, a type of the communication conflict that the base station is capable of solving is determined according to the capability information.

In an embodiment, the type of the communication conflict includes at least one of the following:
the terminal, when communicating with a first base station through the first SIM card, monitoring a paging message sent by a second base station through the second SIM card;
the terminal, when communicating with a first base station through the first SIM card, measuring a signal sent by a second base station through the second SIM card;
the terminal, when communicating with a first base station through the first SIM card, receiving system information sent by a second base station through the second SIM card;
the terminal, when communicating with a first base station through the first SIM card, performing tracking area update by communicating with a second base station through the second SIM card.

In an embodiment, the problem that the base station is capable of solving may include that the terminal leaves the currently accessed base station due to the communication conflict of the plurality of SIM cards. Since there may be a plurality of types of the communication conflicts of the plurality of SIM cards, the capability information may specifically indicate which type of the communication conflict, causing the terminal leaves the currently accessed base station, that the base station is capable of solving.

In an embodiment, when the terminal leaves the currently accessed base station due to the communication conflict of the plurality of SIM cards, on the basis of determining that the base station is capable of solving the problem of the communication conflict, where the problem of the communication conflict is trigger by the communication conflict of the plurality of SIM card which causes the terminal leaving the currently accessed base station, the type of the communication conflict that the base station is capable of solving may be further determined, and that is, the type of the communication conflict that triggers the terminal to leave the currently accessed base station may be combined. If this type is a type of the communication conflict that occurs in the terminal, the problem of the communication conflict may be sent to the base station, otherwise, it is unnecessary to send the problem of the communication conflict to the base station, so as to avoid wasting communication resources when the base station cannot solve the problem of the communication conflict.

For example, the base station is capable of solving the problem of the communication conflict triggered by the following: when communicating with the first base station through the first SIM card, the terminal monitoring the paging message sent by the second base station through the second SIM card. The terminal may not send the problem of the communication conflict to the base station if it is triggered to leave the currently accessed first base station due to communication with the second base station for tracking area update through the second SIM card while communicating with the first base station through the first SIM card, and the terminal may send the problem of the communication conflict to the base station if it is triggered to leave the currently accessed first base station due to monitoring the paging message sent by the second base station through the second SIM card while communicating with the first base station through the first SIM card.

In an embodiment, the system information is newly set system information or the system information is determined by modifying existing system information.

In an embodiment, the system information is minimum system information.

In an embodiment, the system information is other system information.

In an embodiment, the other system information is on demand system information.

Corresponding to the aforementioned embodiments of the method for sending capability and the method for determining capability, the present disclosure also provides embodiments of an apparatus for sending capability and an apparatus for determining capability.

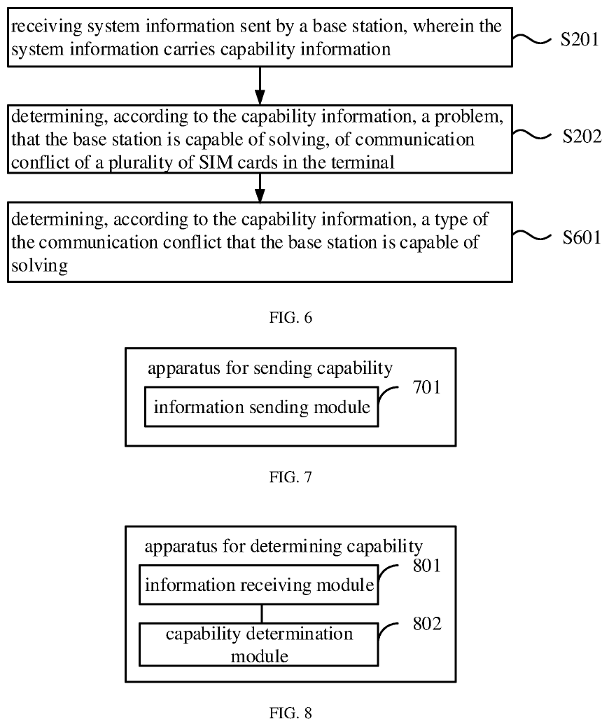

FIG. 7 is a schematic block diagram of an apparatus for sending capability according to an embodiment of the present disclosure. The apparatus for sending capability illustrated in the present embodiment may be applicable to a base station, and the base station includes, but is not limited, to a 4G base station, a 5G base station, and a 6G base station. The base station may communicate with a terminal served as a user equipment, and the terminal includes, but is not limited to, an electronic device such as a mobile phone, a tablet computer and a wearable device, a sensor, and an Internet of Things device. In an embodiment, the terminal may be a terminal to which the apparatus for determining capability in any following embodiment is applicable.

As illustrated in FIG. 7, the apparatus for sending capability may include:
an information sending module 701 configured to send system information, wherein the system information carries capability information;
wherein the capability information is used to indicate a problem, that the base station is capable of solving, of communication conflict of a plurality of SIM cards in a terminal.

In an embodiment, the problem that the base station is capable of solving includes at least one of the following:
paging collision of the plurality of SIM cards in the terminal;
a first SIM card in the terminal being in a process of communication, and a second SIM card in the terminal being required to respond to a paging message;
the terminal leaving a currently accessed base station due to the communication conflict of the plurality of SIM cards.

In an embodiment, the problem that the base station is capable of solving includes the paging collision of the plurality of SIM cards in the terminal, and the capability information is further used to indicate a manner for the base station to solve the paging collision of the plurality of SIM cards in the terminal.

In an embodiment, the manner includes at least one of the following:
changing a user equipment identification of the SIM card, providing an offset corresponding to a user equipment identification of the SIM card, changing an algorithm for determining a paging occasion based on a user equipment identification of the SIM card.

In an embodiment, the problem that the base station is capable of solving includes that the first SIM card in the terminal is in the process of the communication, and the second SIM card in the terminal is required to respond to the paging message, and the capability information is used to indicate that the base station is capable of solving the problem when a paging reason of the paging message is a target reason.

In an embodiment, the problem that the base station is capable of solving includes that the terminal leaves the currently accessed base station due to the communication conflict of the plurality of SIM cards, and the capability information is used to indicate that the base station is capable of solving the problem when a type of the communication conflict is a target type

In an embodiment, the type of the communication conflict includes at least one of the following:
when the terminal communicates with a first base station through the first SIM card, a paging message sent by a second base station being monitored through the second SIM card;
when the terminal communicates with a first base station through the first SIM card, a signal sent by a second base station being measured through the second SIM card;
when the terminal communicates with a first base station through the first SIM card, system information sent by a second base station being received through the second SIM card;
when the terminal communicates with a first base station through the first SIM card, tracking area update being performed through the second SIM card communicating with a second base station.

In an embodiment, the system information is newly set system information or the system information is determined by modifying existing system information.

In an embodiment, the system information is minimum system information.

In an embodiment, the system information is other system information.

In an embodiment, the other system information is on demand system information.

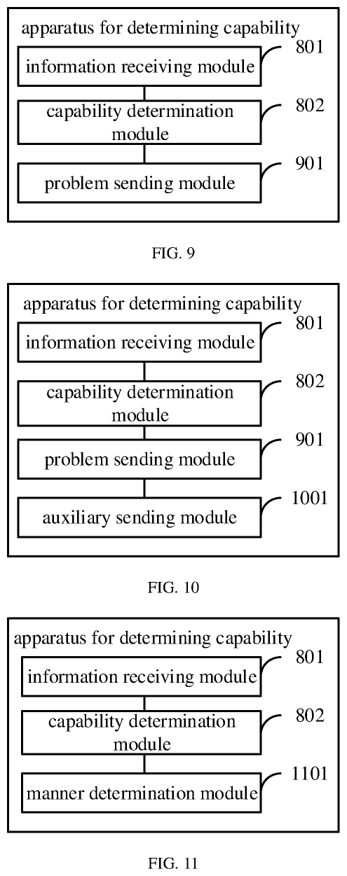

FIG. 8 is a schematic block diagram of an apparatus for determining capability according to an embodiment of the present disclosure. The apparatus for determining capability illustrated in the present embodiment may be applicable to a terminal, and the terminal includes, but is not limited to, an electronic device such as a mobile phone, a tablet computer and a wearable device, a sensor, and an Internet of Things device. The terminal may communicate with a base station served as a user equipment. The base station includes, but is not limited to, a 4G base station, a 5G base station, and a 6G base station. In an embodiment, the base station may be a base station to which the apparatus for sending capability described in any of the above embodiments is applicable.

As illustrated in FIG. 8, the apparatus for determining capability may include:
an information receiving module 801 configured to receive system information sent by a base station, wherein the system information carries capability information;
a capability determination module 802 configured to determine, according to the capability information, a problem, that the base station is capable of solving, of communication conflict of a plurality of SIM cards in the terminal.

FIG. 9 is a schematic block diagram of another apparatus for determining capability according to an embodiment of the present disclosure. As illustrated in FIG. 9, in some embodiments of the present disclosure, the terminal is provided with a plurality of SIM cards, and the apparatus further includes:
a problem sending module 901 configured to send the problem of the communication conflict to the base station in response to that the plurality of SIM cards have the problem of the communication conflict and in case that the problem of the communication conflict is the problem that the base station is capable of solving.

FIG. 10 is a schematic block diagram of yet another apparatus for determining capability according to an embodiment of the present disclosure. As illustrated in FIG. 10, in some embodiments of the present disclosure, the apparatus further includes:
an auxiliary sending module 1001 configured to send auxiliary information to the base station, wherein the auxiliary information is used to assist the base station to solve the problem of the communication conflict of the terminal.

In an embodiment, the auxiliary information includes at least one of the following:
a manner of solving the problem of the communication conflict of the terminal, a time of solving the problem of the communication conflict of the terminal, a priority of solving the problem of the communication conflict of the terminal.

In an embodiment, the problem that the base station is capable of solving includes at least one of the following:
paging collision of the plurality of SIM cards in the terminal;
a first SIM card in the terminal being in a process of communication, and a second SIM card in the terminal being required to respond to a paging message;
the terminal leaving a currently accessed base station due to the communication conflict of the plurality of SIM cards.

FIG. 11 is a schematic block diagram of yet another apparatus for determining capability according to an embodiment of the present disclosure. As illustrated in FIG. 11, in some embodiments of the present disclosure, the problem that the base station is capable of solving includes the paging collision of the plurality of SIM cards in the terminal, and the apparatus further includes:
a manner determination module 1101 configured to determine according to the capability information, a manner for the base station to solve the paging collision of the plurality of SIM cards in the terminal.

In an embodiment, the manner includes at least one of the following:
changing a user equipment identification of the SIM card, providing an offset corresponding to a user equipment identification of the SIM card, changing an algorithm for determining a paging occasion based on a user equipment identification of the SIM card.

In an embodiment, the problem that the base station is capable of solving includes that the first SIM card in the terminal is in the process of the communication, and the second SIM card in the terminal is required to respond to the paging message, and the capability determination module is configured such that the base station is capable of solving the problem when a paging reason of the paging message is a target reason.

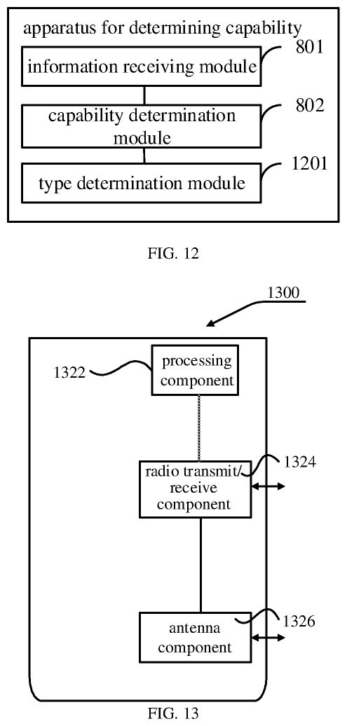

FIG. 12 is a schematic block diagram of yet another apparatus for determining capability according to an embodiment of the present disclosure. As illustrated in FIG. 12, in some embodiments of the present disclosure, the problem that the base station is capable of solving includes that the terminal leaves the currently accessed base station due to the communication conflict of the plurality of SIM cards, and the apparatus further includes:
a type determination module 1201 configured to determine a type of the communication conflict that the base station is capable of solving according to the capability information.

In an embodiment, the type of the communication conflict includes at least one of the following:
the terminal, when communicating with a first base station through the first SIM card, monitoring a paging message sent by a second base station through the second SIM card;
the terminal, when communicating with a first base station through the first SIM card, measuring a signal sent by a second base station through the second SIM card;
the terminal, when communicating with a first base station through the first SIM card, receiving system information sent by a second base station through the second SIM card;
the terminal, when communicating with a first base station through the first SIM card, performing tracking area update by communicating with a second base station through the second SIM card.

In an embodiment, the system information is newly set system information or the system information is determined by modifying existing system information.

In an embodiment, the system information is minimum system information.

In an embodiment, the system information is other system information.

In an embodiment, the other system information is on demand system information.

With respect to the apparatus in the above embodiments, the specific manner in which each module performs its operation is already described in detail in the relevant method embodiment, and will not be repeated here.

For the apparatus embodiments, since it corresponds generally to the method embodiments, it is sufficient to refer to the method embodiments for the relevant part of the description. The apparatus embodiments described above are merely schematic, where the modules described as separate components may or may not be physically separated, and the components shown as modules may or may not be physical modules, i.e., they may be located in one place or may be distributed to multiple network modules. Some or all of these modules can be selected according to practical needs to achieve the purpose of the solution of the embodiments. It can be understood and implemented by a person of ordinary skill in the art without departing from this application.

The embodiments of the present disclosure further provides an electronic device, and the electronic device includes:
a processor;
a memory for storing executable instructions of the processor;
where the processor is configured to execute the method for the sending capability described in any one of above embodiments.

The embodiments of the present disclosure further provides an electronic device, and the electronic device includes:
a processor;
a memory for storing executable instructions of the processor;
where the processor is configured to execute the method for determining capability described in any one of above embodiments.

The embodiments of the present disclosure further provides a computer-readable storage medium storing a computer program, where the program, when executed by a processor, implements steps in the method for sending capability described in any one of above embodiments.

The embodiments of the present disclosure further provides a computer-readable storage medium storing a computer program, where the program, when executed by a processor, implements steps in the method for determining capability described in any one of above embodiments.

As shown in FIG. 13, FIG. 13 is a schematic block diagram of an apparatus 1300 for sending capability according to the embodiments of the present disclosure. The apparatus 1300 may be served as a base station. Referring to FIG. 13, the apparatus 1300 includes a processing component 1322, a radio transmit/receive component 1324, an antenna component 1326, and a signal processing portion specific to the radio interface, and the processing component 1322 may further include one or more processors. One of the processors in the processing component 1322 may be configured to implement the method for sending capability as described in any one of above embodiments.

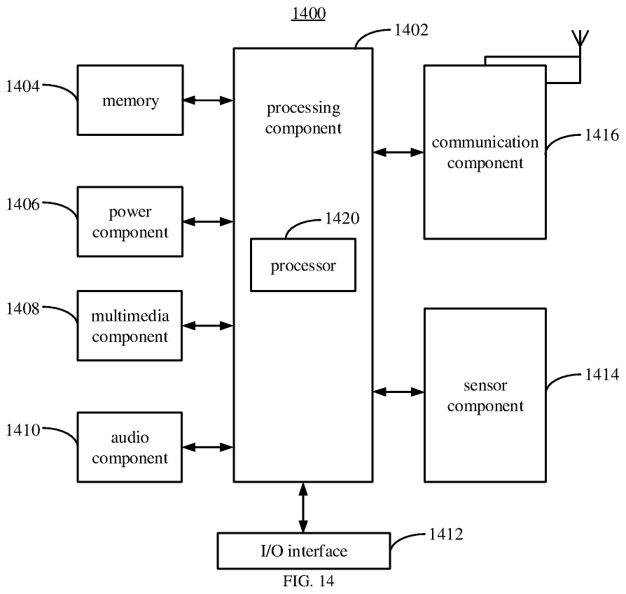

FIG. 14 is a schematic block diagram of an apparatus 1400 for determining capability according to the embodiments of the present disclosure. For example, the apparatus 1400 may be may be a mobile phone, a computer, a digital broadcast terminal, a message sending and receiving device, a game console, a tablet device, a medical device, a fitness device, a personal digital assistant, and the like.

Referring to FIG. 14, the apparatus 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls the overall operation of the apparatus 1400, such as operations associated with display, phone call, data communication, camera operation, and recording operations. The processing component 1402 may include one or more processors 1420 to execute instructions to complete all or some of the steps of the method for determining capability described above. In addition, the processing component 1402 may include one or more modules that facilitate interaction between processing component 1402 and other components. For example, processing component 1402 may include a multimedia module to facilitate interaction between multimedia component 1408 and processing component 1402.

The memory 1404 is configured to store various types of data to support operation at the apparatus 1400. Examples of such data include instructions for any application or method of operation on the apparatus 1400, contact data, phonebook data, messages, images, videos, etc. The memory 1404 can be implemented by any type of transitory or non-transitory storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or CD.

The power component 1406 provides power to the various components of the apparatus 1400. The power component 1406 may include a power management system, one or more power supplies, and other components associated with generating, managing, and distributing power for the apparatus 1400.

The multimedia component 1408 includes a screen providing an output interface between the apparatus 1400 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of the touch or swipe action, but also detect the duration and pressure associated with the touch or swipe action. In some embodiments, the multimedia component 1408 includes a front-facing camera and/or a rear-facing camera. The front camera and/or rear camera can receive external multimedia data when the apparatus 1400 is in an operating mode, such as shooting mode or video mode. Each front camera and rear camera may be a fixed optical lens system or have focal length and optical zoom capability.

The audio component 1410 is configured to output and/or input audio signals. For example, the audio component 1410 includes a microphone (MIC) configured to receive external audio signals when the apparatus 1400 is in an operating mode, such as call mode, recording mode, and voice recognition mode. The received audio signal may be further stored in memory 1404 or sent via communication component 1416. In some embodiments, the audio component 1410 further includes a speaker for outputting audio signals.

The I/O interface 1412 provides an interface between the processing component 1402 and a peripheral interface module, the peripheral interface module may be a keyboard, click wheel, button, etc. These buttons may include, but are not limited to: a home button, a volume button, a start button, and a lock button.

The sensor component 1414 includes one or more sensors for providing status assessment of various aspects of the apparatus 1400. For example, the sensor component 1414 may detect an open/closed state of the apparatus 1400, the relative positioning of components, such as the components being the display and keypad of the apparatus 1400, the sensor component 1414 may also detect a change in position of the apparatus 1400 or a component of the apparatus 1400, the presence or absence of user contact with the apparatus 1400, the orientation or acceleration/deceleration of the apparatus 1400 and temperature changes of the apparatus 1400. The sensor component 1414 may include a proximity sensor configured to detect the presence of a nearby object in the absence of any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication between the apparatus 1400 and other devices by wired or wireless means. The apparatus 1400 may access a wireless network based on a communication standard, such as WiFi, 2G, 3G, 4G (LTE), 5G, or a combination thereof. In one embodiment, communication component 1416 receives broadcast signals or broadcast-related information from an external broadcast management system via a broadcast channel In an embodiment, the communication component 1416 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In some embodiments, the apparatus 1400 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the method for determining capability as described in any one of the above embodiments.

In some embodiments, there is also provided a non-transitory computer readable storage medium including instructions, such as a memory 1404 including instructions, the instructions being executable by the processor 1420 of the apparatus 1400 to implement the method described above. For example, said non-transitory computer readable storage medium may be ROM, random access memory (RAM), CD-ROM, magnetic tape, floppy disk, and optical data storage devices, among others.

Those skilled in the art will easily expect other embodiments of the present disclosure upon consideration of the specification and practice of the disclosure disclosed herein. This disclosure is intended to cover any variations, uses, or adaptations of the present disclosure that follow the general principles of the present disclosure and include commonly known or customary technical means in the art that are not disclosed herein. The specification and embodiments are considered exemplary only, and the true scope and spirit of the present disclosure is indicated by the following claims.

It should be understood that the present disclosure is not limited to the precise structure already described above and illustrated in the accompanying drawings, and that various modifications and changes may be made without departing from its scope. The scope of the present disclosure is limited only by the appended claims.

It is noted that in this document, relationship terms such as “first” and “second” are used only to distinguish one entity or operation from another, and do not necessarily require or imply any such actual relationship or order between these entities or operations. The term “includes,” “comprises,” or any other variation thereof, is intended to cover non-exclusive inclusion so that a process, method, article, or apparatus that includes a set of elements includes not only those elements, but also other elements not explicitly listed, or also includes the process, method, article, or apparatus for which such process, method, article, or apparatus is intended, or further include elements that are inherent to such process, method, article, or apparatus. Without further limitation, the elements defined by the statement “including a/an . . . ” do not preclude the existence of additional identical elements in the process, method, article, or device that includes the elements.

The method and apparatus provided by the embodiments of the present disclosure are described in detail above, and specific examples are used to illustrate the principles and implementation of the present disclosure. The above description of the embodiments is only used to help understand the method of the present disclosure and its core ideas; at the same time, for a person of ordinary skill in the art, there will be changes in the specific implementation and scope of application based on the ideas of the present disclosure, and in summary, the contents of this specification should not be construed as a limitation of the present disclosure.

1. A method for sending capability, performed by a base station, comprising:
sending system information, wherein the system information carries capability information;
wherein the capability information is configured to indicate a problem, that the base station is capable of solving, of communication conflict of a plurality of subscriber identity module (SIM) cards in a terminal.

2. The method according to claim 1, wherein the problem that the base station is capable of solving comprises at least one of:
paging collision of the plurality of SIM cards in the terminal;
a first SIM card in the terminal being in a process of communication, and a second SIM card in the terminal being required to respond to a paging message; or
the terminal leaving a currently accessed base station due to the communication conflict of the plurality of SIM cards.

3. The method according to claim 2, wherein the problem that the base station is capable of solving comprises the paging collision of the plurality of SIM cards in the terminal, and the capability information is further configured to indicate a manner for the base station to solve the paging collision of the plurality of SIM cards in the terminal.

4. The method according to claim 3, wherein the manner comprises at least one of:
changing a user equipment identification of the SIM card, providing an offset corresponding to a user equipment identification of the SIM card, or changing an algorithm for determining a paging occasion based on a user equipment identification of the SIM card.

5. The method according to claim 2, wherein the problem that the base station is capable of solving comprises that the first SIM card in the terminal is in the process of the communication, and the second SIM card in the terminal is required to respond to the paging message, and the capability information is configured to indicate that the base station is capable of solving the problem in case that a paging reason of the paging message is a target reason.

6. The method according to claim 2, wherein the problem that the base station is capable of solving comprises that the terminal leaves the currently accessed base station due to the communication conflict of the plurality of SIM cards, and the capability information is configured to indicate that the base station is capable of solving the problem in case that a type of the communication conflict is a target type.

7. The method according to claim 6, wherein the type of the communication conflict comprises at least one of:
in case that the terminal communicates with a first base station through the first SIM card, a paging message sent by a second base station being monitored through the second SIM card;
in case that the terminal communicates with a first base station through the first SIM card, a signal sent by a second base station being measured through the second SIM card;
in case that the terminal communicates with a first base station through the first SIM card, system information sent by a second base station being received through the second SIM card; or
in case that the terminal communicates with a first base station through the first SIM card, tracking area update being performed through the second SIM card communicating with a second base station.

8. The method according to claim 1, wherein the system information is one of:
newly set system information;
system information determined by modifying existing system information;
minimum system information; or
other system information, wherein the other system information is on demand system information.

9.-11. (canceled)

12. A method for determining capability, performed by a terminal, comprising:
receiving system information sent by a base station, wherein the system information carries capability information; and
determining, according to the capability information, a problem, that the base station is capable of solving, of communication conflict of a plurality of subscriber identity module (SIM) cards in the terminal.

13. The method according to claim 12, wherein the plurality of SIM cards are provided in the terminal, and the method further comprises:
sending, in response to that the plurality of SIM cards have a first problem of communication conflict and in case that the first problem of the communication conflict is the problem that the base station is capable of solving, the first problem of the communication conflict to the base station.

14. The method according to claim 13, further comprising:
sending auxiliary information to the base station, wherein the auxiliary information is configured to assist the base station to solve the first problem of the communication conflict of the terminal.

15. The method according to claim 14, wherein the auxiliary information comprises at least one of:
a manner of solving the first problem of the communication conflict of the terminal, a time of solving the first problem of the communication conflict of the terminal, or a priority of solving the first problem of the communication conflict of the terminal.

16. The method according to claim 12, wherein that the problem that the base station is capable of solving comprises at least one of:
paging collision of the plurality of SIM cards in the terminal;
a first SIM card in the terminal being in a process of communication, and a second SIM card in the terminal being required to respond to a paging message; or
the terminal leaving a currently accessed base station due to the communication conflict of the plurality of SIM cards.

17. The method according to claim 16, wherein the problem that the base station is capable of solving comprises the paging collision of the plurality of SIM cards in the terminal, and the method further comprises:
determining, according to the capability information, a manner for the base station to solve the paging collision of the plurality of SIM cards in the terminal.

18. The method according to claim 17, wherein the manner comprises at least one of:
changing a user equipment identification of the SIM card, providing an offset corresponding to a user equipment identification of the SIM card, or changing an algorithm for determining a paging occasion based on a user equipment identification of the SIM card.

19. The method according to claim 16, wherein the problem that the base station is capable of solving comprises that the first SIM card in the terminal is in the process of the communication and the second SIM card in the terminal is required to respond to the paging message, and the determining, according to the capability information, the problem, that the base station is capable of solving, of the communication conflict of the plurality of SIM cards in the terminal comprises:
the base station being capable of solving the problem in case that a paging reason of the paging message is a target reason.

20. The method according to claim 16, wherein the problem that the base station is capable of solving comprises that the terminal leaves the currently accessed base station due to the communication conflict of the plurality of SIM cards, and the method further comprises:
determining, according to the capability information, a type of the communication conflict that the base station is capable of solving.

21. The method according to claim 20, wherein the type of the communication conflict comprises at least one of:
the terminal, in case that communicating with a first base station through the first SIM card, monitoring a paging message sent by a second base station through the second SIM card;
the terminal, in case that communicating with a first base station through the first SIM card, measuring a signal sent by a second base station through the second SIM card;
the terminal, in case that communicating with a first base station through the first SIM card, receiving system information sent by a second base station through the second SIM card; or
the terminal, in case that communicating with a first base station through the first SIM card, performing tracking area update by communicating with a second base station through the second SIM card.

22.-27. (canceled)

28. A base station, comprising:
a processor; and
a memory for storing executable instructions of the processor;
wherein the processor is configured to:
send system information, wherein the system information carries capability information;
wherein the capability information is configured to indicate a problem, that the base station is capable of solving, of communication conflict of a plurality of subscriber identity module (SIM) cards in a terminal.

29. A terminal, comprising:
a processor; and
a memory for storing executable instructions of the processor;
wherein the processor is configured to perform the method according to claim 12.

30. (canceled)

31. (canceled)
